(19) United States
(12) Patent Application Publication
(10) Pub. No.: US 2025/0277887 A1
(43) Pub. Date: Sep. 4, 2025

(54) SENSING DEVICE AND OPERATION METHOD THEREOF

(71) Applicant: LG INNOTEK CO., LTD., Seoul (KR)

(72) Inventors: Hyuk Kyung KWON, Seoul (KR); Jeong Woo WOO, Seoul (KR); Seung Joon LEE, Seoul (KR)

(21) Appl. No.: 18/293,402

(22) PCT Filed: Jul. 29, 2022
(86) PCT No.: PCT/KR2022/011235

§ 371 Date: Jul. 3, 2024

(30) Foreign Application Priority Data
Jul. 30, 2021 (KR) 10-2021-0100962

(51) Int. Cl. G01S 7/35; G01S 13/04; G01S 13/88

(52) U.S. Cl. CPC G01S 7/352; G01S 13/04; G01S 13/88

(57) ABSTRACT

A method of operating a sensing device according to an embodiment includes driving an antenna unit in a first operation mode; obtaining a first reception signal in the first operation mode; driving the antenna unit in a second operation mode different from the first operation mode; obtaining a second reception signal in the second operation mode; obtaining a composite signal by compositing the first reception signal and the second reception signal; and obtaining object detection information by using the obtained composite signal.

### TECHNICAL FIELD

An embodiment relates to a sensing device, particularly a sensing device including a radar module, a sensing system for a vehicle, and a method of operating the same.

### BACKGROUND ART

A radar device is applied to various technical fields, and recently is installed in a vehicle to improve a mobility of the vehicle. Such a radar device uses electromagnetic waves to detect information about the surrounding environment of a vehicle. In addition, by using the corresponding information for moving a vehicle, efficiency of the movement of the vehicle can be improved. To this end, the radar device includes an antenna to transmit and receive electromagnetic waves.

Meanwhile, a vehicle radar may be classified into a long range radar (LRR) and a short range radar (SRR), and in the case of LRR, a frequency of 77 GHz band is mainly used, and in the case of SRR, a 24 GHz band is mainly used.

In order for a vehicle radar including both a LRR and a SRR to secure a field of view (FOV) and detection distance for simultaneously detecting objects placed at a long distance and a short distance, it is necessary to dispose an optimal interval between antenna channels and secure an antenna gain.

Meanwhile, a conventional radar device uses either MIMO (Multi Input Multi Output) mode or beam forming mode for signal processing depending on a target distance or application. For example, a conventional radar device allows an antenna unit to operate in either MIMO (Multi Input Multi Output) mode or beam forming mode, and allows obtaining sensing information through processing of the reception signal received according to the corresponding mode.

However, in the related art, the sensing information is obtained using only one of the reception signals obtained in the MIMO (Multi Input Multi Output) mode and the reception signal obtained in the beam forming mode.

At this time, the signal received in the MIMO (Multi Input Multi Output) mode has a high angle resolution, but there is a problem of low signal strength due to low gain. In addition, the signal received in the beam forming mode has a strong signal strength due to high gain, but has a low angle resolution compared to the signal received in the MIMO (Multi Input Multi Output) mode.

Accordingly, there is a problem in that it is difficult to efficiently provide a rear occupancy alert (ROA) function inside a vehicle using a conventional radar device.

For example, the rear occupancy alert function generally senses a moving object (e.g., a passenger or a pet) in a rear seat inside a vehicle and provides a notification function for this.

At this time, if the rear occupancy alert function is provided using a reception signal received through MIMO (Multi Input Multi Output) mode, the strength of the reception signal is weak due to low gain, and there is a problem in which small moving objects (for example, infants) cannot be sensed properly.

Furthermore, if the rear occupancy alert function is provided using a reception signal received through beam forming mode, detection of small-sized moving objects is possible due to high gain, but a strength of the noise signal is also reduced accordingly. As a result, there is a false alarm problem in which the noise signal is recognized as a moving object and an alarm is generated. Furthermore, if providing the rear occupancy alert function using a reception signal received through the beam forming mode, there is a problem that the signal of a large moving object appears spread out due to low angle resolution, and as a result, there is a problem of not sensing the exact position of the moving object.

Accordingly, there is a need for a method that can sense all moving objects regardless of size, improve the signal to noise ratio (SNR), and accurately sense a position of the detected moving object.

### DISCLOSURE

### Technical Problem

The embodiment provides a sensing device capable of sensing a moving object by processing a reception signal in a new method, a sensing system for a vehicle, and a method of operating the same.

In addition, the embodiment provides a sensing device capable of sensing a moving object using a composite signal obtained by compositing the MIMO (Multi Input Multi Output) method and the beam forming method, a sensing system for a vehicle, and a method of operating the same.

In addition, the embodiment provides a sensing device that can increase a gain and angle resolution of a reception signal that senses a moving object, a sensing system for a vehicle, and a method of operating the same.

In addition, the embodiment provides a sensing device that can increase sensing accuracy of a moving object, a sensing system for a vehicle, and a method of operating the same.

Technical problems to be solved by the proposed embodiments are not limited to the above-mentioned technical problems, and other technical problems not mentioned may be clearly understood by those skilled in the art to which the embodiments proposed from the following descriptions belong.

### Technical Solution

A method of operating a sensing device according to an embodiment comprises driving an antenna unit in a first operation mode; obtaining a first reception signal in the first operation mode; driving the antenna unit in a second operation mode different from the first operation mode; obtaining a second reception signal in the second operation mode; obtaining a composite signal by compositing the first reception signal and the second reception signal; and obtaining object detection information by using the obtained composite signal.

In addition, the first operation mode is MIMO (Multi Input Multi Output) mode, and the second operation mode is beam forming mode.

In addition, the first reception signal includes a first heat map, and the second reception signal includes a second heat map.

In addition, the antenna unit includes a plurality of transmitting antennas, and wherein the driving the antenna unit in the first operation mode includes allowing transmission signals to be transmitted from each of the plurality of transmitting antennas at a certain time interval, and wherein the driving the antenna unit in the second operation mode includes simultaneously operating the plurality of transmitting antennas to transmit one transmission signal.

In addition, the obtaining of the composite signal includes normalizing the first reception signal and the second reception signal.

In addition, the normalizing of the first reception signal and the second reception signal includes determining a first scale factor for scaling the first reception signal; determining a second scale factor for scaling the second reception signal; scaling the first reception signal based on the first scale factor; and scaling the second reception signal based on the second scale factor.

In addition, the first scale factor is greater than 1 and the second scale factor is less than 1, wherein the scaling the first reception signal includes scaling up the first reception signal based on the determined first scale factor, and wherein the scaling the second reception signal includes scaling down the second reception signal based on the determined second scale factor.

In addition, the obtaining the composite signal includes obtaining the composite signal by multiplying the first reception signal and the second reception signal.

In addition, the obtaining the object detection information includes obtaining information including presence or absence of the object, a number of objects, and a position of the object.

Meanwhile, a sensing device according to an embodiment comprises a transmitting antenna unit including a plurality of transmitting antennas; a receiving antenna unit including a plurality of receiving antennas; a reception signal processing unit configured to process signals received through the receiving antenna unit; and a control unit configured to detect an object using a signal processed through the reception signal processing unit, wherein the control unit is configured to: control the transmitting antenna unit and the receiving antenna unit to operate in a first operation mode, control the first reception signal to be generated through the reception signal processing unit in the first operation mode, control the transmitting antenna unit and the receiving antenna unit to operate in a second operation mode different from the first operation mode, control a second reception signal to be generated through the reception signal processing unit in the second operation mode, control a composite signal to be generated by compositing the first reception signal and the second reception signal through the signal processing unit, and detect the object using the generated composite signal.

In addition, the first operation mode is MIMO (Multi Input Multi Output) mode, the second operation mode is beam forming mode, and wherein the control unit is configured to allow transmission signals to be transmitted from each of the plurality of transmitting antennas at a certain time interval, and allow simultaneously operate the plurality of transmitting antennas to transmit one transmission signal.

In addition, the reception signal processing unit includes a first reception signal generation unit configured to generate the first reception signal, and a second reception signal generation unit configured to generate the second reception signal, and a normalization unit configured to normalize the generated first and second reception signals.

In addition, the normalization unit is configured to determine a first scale factor for the first reception signal and a second scale factor for the second reception signal, and to scale and normalize the first and second reception signals based on the determined first scale factor and second scale factor.

In addition, the first scale factor is greater than 1, the second scale factor is less than 1, and wherein the normalization unit is configured to increase the level of the first reception signal based on the first scale factor and to decrease the level of the second reception signal based on the second scale factor.

In addition, the reception signal processing unit includes a composite unit configured to generate the composite signal by compositing the first reception signal and the second reception signal normalized through the normalization unit.

In addition, the control unit is configured to detect a presence or absence of an object, a number of objects, and a position of the object using the composite signal generated through the composite unit.

### Advantageous Effects

The embodiment may improve sensing accuracy of a sensing device. For example, the embodiment may improve an angle resolution of a detection signal obtained through a sensing device. Accordingly, the embodiment can increase the signal level and remove noise.

Specifically, the sensing device of the embodiment may operate an antenna unit in MIMO (Multi Input Multi Output) mode and obtain a first reception signal accordingly. At this time, the first reception signal has high angle resolution, but has a low signal level. Thereafter, the sensing device of the embodiment may operate the antenna unit in beam forming mode and obtain a second reception signal accordingly. At this time, the second reception signal has a high signal level, but has low angle resolution. Accordingly, the embodiment performs normalization to match a level of the first reception signal and a level of the second reception signal, and generates a composite signal by compositing the normalized first reception signal and the second reception signal. At this time, the composite signal has characteristics of having a higher angle resolution compared to the first reception signal and a higher signal level compared to the second reception signal. Accordingly, the embodiment performs an object detection operation using a composite signal compositing the first reception signal and the second reception signal, so that the object sensing accuracy can be improved. For example, the composite signal may be obtained through a multiplication operation between elements of the first reception signal and the second reception signal. Accordingly, the noise can be removed through the multiplication operation, and further, an actual object detection signal can be increased.

Accordingly, the embodiment can prevent false alarms from occurring due to noise by reducing the noise value of the composite signal.

In addition, the embodiment allows detection of even small-sized objects by generating a composite signal through the multiplication operation, thereby improving detection accuracy.

In addition, the embodiment can generate a composite signal through the multiplication operation to improve the angle resolution of the composite signal, thereby improving the number of detected objects and the location accuracy of the objects.

### DESCRIPTION OF DRAWINGS

FIG. 1 is an exploded perspective view of a sensing device for a vehicle according to an embodiment.

FIG. 2 is a block diagram showing an internal configuration of a sensing device according to an embodiment.

FIG. 3 is a perspective view showing a radome and a second substrate of a vehicle radar device according to an embodiment.

FIG. 4 is a plan view showing a transmitting antenna according to a first embodiment.

FIG. 5 is a plan view showing a transmitting antenna according to a second embodiment.

FIG. 6 is a plan view showing a first receiving antenna according to a first embodiment.

FIG. 7 is a plan view showing a receiving antenna according to a second embodiment.

FIGS. 8 to 10 are views for explaining an operation mode of an antenna unit according to an embodiment.

FIG. 11 is a block diagram showing a detailed configuration of a reception signal processing unit according to an embodiment.

FIGS. 12(a) and (b) are views showing a first reception signal according to an embodiment.

FIGS. 13(a) and (b) are views showing a second reception signal according to an embodiment.

FIG. 14 is a view showing a composite signal according to an embodiment.

FIG. 15 is a flowchart for explaining a method for operating a sensing device according to an operation sequence according to an embodiment.

FIG. 16 is a flowchart showing a detailed operation of a process of generating a composite signal of FIG. 15.

### MODES OF THE INVENTION

Hereinafter, exemplary embodiments of the present invention will be described in detail with reference to the accompanying drawings, wherein like reference numerals are used to designate identical or similar elements, and redundant description thereof will be omitted. The suffix “module” and “portion” of the components used in the following description are only given or mixed in consideration of ease of preparation of the description, and there is no meaning or role to be distinguished as it is from one another. Also, in the following description of the embodiments of the present invention, a detailed description of related arts will be omitted when it is determined that the gist of the embodiments disclosed herein may be obscured. Also, the accompanying drawings are included to provide a further understanding of the invention, are incorporated in, and constitute a part of this description, and it should be understood that the invention is intended to cover all modifications, equivalents, or alternatives falling within the spirit and scope of the invention.

Terms including ordinals, such as first, second, etc., may be used to describe various components, but the elements are not limited to these terms. The terms are used only for distinguishing one component from another.

When a component is referred to as being “connected” or “joined” to another component, it may be directly connected or joined to the other component, but it should be understood that other component may be present therebetween. When a component is referred to as being “directly connected” or “directly joined” to another component, it should be understood that other component may not be present therebetween.

A singular representation includes plural representations, unless the context clearly implies otherwise.

In the present application, terms such as “including” or “having” are used to specify the presence of features, numbers, steps, operations, components, parts, or combinations thereof described in the description. However, it should be understood that the terms do not preclude the presence or addition of one or more other features, numbers, steps, operations, components, parts, or combinations thereof.

Hereinafter, embodiments of the present invention will be described in detail with reference to the attached drawings.

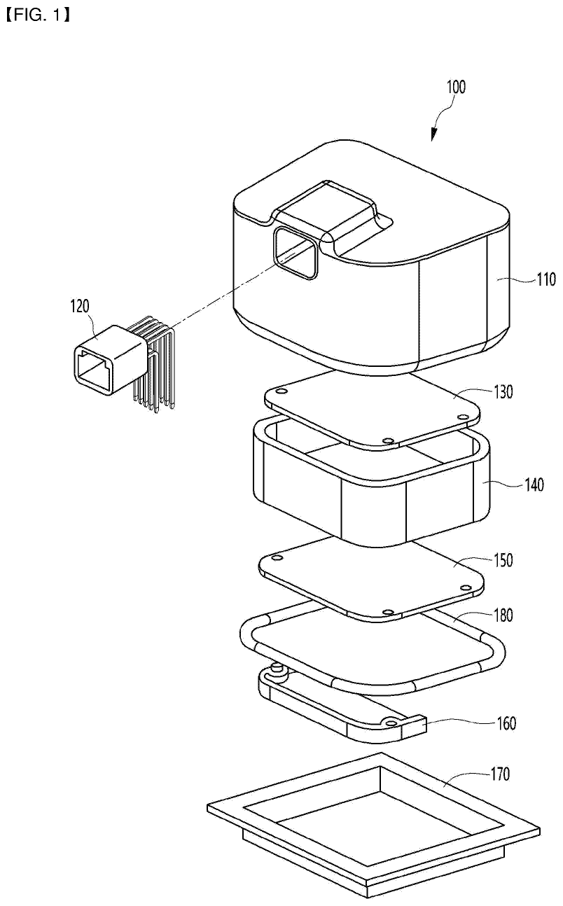

FIG. 1 is an exploded perspective view of a sensing device for a vehicle according to an embodiment.

In an embodiment, the sensing device for a vehicle may be an In-Cabin Radar. For example, in the embodiment, the sensing device for a vehicle is installed inside the vehicle, and thus can provide various detection notification information to the user inside the vehicle. For example, in an embodiment, the sensing device for a vehicle is installed inside the vehicle, and thus may provide a rear occupancy alert (ROA) function. However, the embodiment is not limited thereto, and the vehicle sensing device of the embodiment may be equipped to provide other functions in addition to the rear occupancy alert (ROA: Rear Occupancy Alert) function.

Referring to FIG. 1, the vehicle radar device 100 includes a case 110, a connector 120, a first substrate 130, a bracket 140, a second substrate 150, a shield unit 160, a radome 170 and a waterproof ring 180.

The case 110 can accommodate a connector 120, a first substrate 130, a bracket 140, a second substrate 150, and a shield unit 160.

The connector 120 can transmit and receive signals between the vehicle radar device 100 and an external device. For example, the connector 120 may be a controller area network (CAN) connector, but is not limited thereto.

The first substrate 130 may be equipped with circuits for power and signal processing, but is not limited thereto.

The bracket 140 may block noise generated during signal processing of the first substrate 130.

The second substrate 150 may be equipped with a plurality of antenna arrays and an integrated circuit (IC) chip connected to the plurality of antenna arrays. The plurality of antenna arrays may include a plurality of wide-angle antennas arranged in a row, but are not limited thereto. The IC chip may be a millimeter wave RFIC (radio frequency IC), but is not limited thereto.

The IC chip may include a communication device connected to a transmitting antenna and a receiving device connected to a receiving antenna. However, the embodiment is not limited thereto, and the IC chip may be commonly connected to a transmitting antenna and a receiving antenna, and may be an integrated device that processes both transmission signals and reception signals accordingly.

Depending on the embodiment, the first substrate 130 may be equipped with the plurality of antenna arrays and an IC chip connected to the plurality of antenna arrays. The first substrate 130 and the second substrate 150 may be arranged to be spaced apart with the bracket 140 therebetween.

The shield unit 160 may shield RF signals generated from the IC chip of the second substrate 150. To this end, the shielding unit 160 may be provided in a region of the second substrate 150 corresponding to the IC chip.

The radome 170 may accommodate the second substrate 150 to protect the second substrate 150, and the radome 170 may be fastened to the case 110. The radome 170 may be made of a material that has low attenuation of radio waves and may be an electrical insulator.

The waterproof ring 180 is disposed between the radome 170 and the case 110 to prevent the vehicle radar device 100 from being submerged. For example, the waterproof ring 180 may be formed of an elastic material.

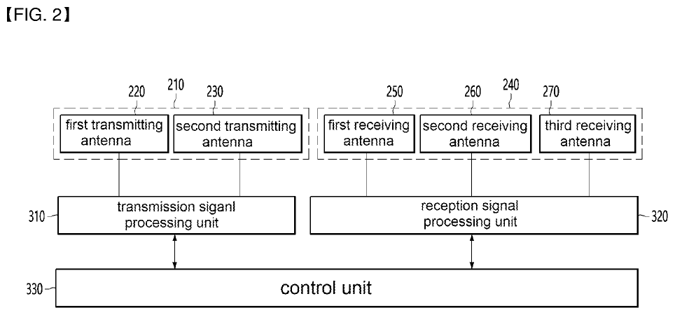

FIG. 2 is a block diagram showing an internal configuration of a sensing device according to an embodiment.

Referring to FIG. 2, the sensing device may include an antenna unit, a signal processing unit, and a control unit.

Referring to FIG. 2, the sensing device can perform the function of sensing a moving object in a region surrounding a current position. That is, the sensing device can detect information about the surrounding environment through electromagnetic waves, and thus sense the movement of the moving object according to the movement of the moving object.

The antenna unit may include a transmitting antenna unit 210 and a receiving antenna unit 240. The transmitting antenna unit 210 may include a plurality of transmitting antennas. For example, the transmitting antenna unit 210 may include a first transmitting antenna 220 and a second transmitting antenna 230. At this time, in the embodiment, the transmitting antenna unit 210 is shown as including two transmitting antennas, but it is not limited thereto. For example, the transmitting antenna unit 210 may include three or more transmitting antennas.

At this time, the antenna unit can perform the function of transmitting and receiving wireless signals of the sensing device. That is, the antenna unit can transmit a transmission signal into an air and receive a reception signal from an air accordingly. For example, a transmission signal may refer to a wireless signal transmitted from a sensing device. And, the reception signal may refer to a wireless signal providing into the sensing device as the transmission signal transmitted from the sensing device is reflected by a target (e.g., object).

The transmitting antenna unit 210 can transmit a transmission signal into the air. The transmitting antenna unit 210 may include a first transmitting antenna 220 and a second transmitting antenna 230. At this time, the first transmitting antenna 220 and the second transmitting antenna 230 may have the same antenna array structure, or may have different antenna array structures.

The receiving antenna unit 240 may receive a reception signal corresponding to a transmission signal transmitted through the transmitting antenna unit 210. For example, the receiving antenna unit 240 may receive a reflected signal as the transmission signal transmitted through the transmitting antenna unit 210 is reflected by an object.

The receiving antenna unit 240 may include a plurality of receiving antennas.

For example, the receiving antenna unit 240 may include a first receiving antenna 250, a second receiving antenna 260, and a Nth receiving antenna 270. For example, the receiving antenna unit 240 may include N receiving antennas. The N may be greater than ‘2’. For example, N may be greater than ‘4’. For example, N may be greater than ‘8’.

Meanwhile, the sensing device includes a signal processing unit.

For example, the signal processing unit may include a transmission signal processing unit 310 and a reception signal processing unit 320.

At this time, the transmission signal processing unit 310 and the reception signal processing unit 320 may perform the function of processing the wireless signal of the sensing device. At this time, the transmission signal and reception signal can be processed separately. However, the embodiment is not limited to this, and the signal processing unit may include only one signal processing device that processes both transmission signals and reception signals.

The transmission signal processing unit 310 may generate a transmission signal from transmission data. The transmission signal processing unit 310 may output a transmission signal to the transmitting antenna 210. To this end, the transmission signal processing unit 310 may be provided with an oscillating unit (not shown), and for example, the oscillating unit may include a voltage controlled oscillator (VCO) and an oscillator.

The reception signal processing unit 320 may receive a reception signal from the receiving antenna unit 240.

The reception signal processing unit 320 may generate a composite signal from the reception signal. To this end, the reception signal processing unit 320 may include a low noise amplifier (LNA; not shown) and an analog-to-digital converter (ADC; not shown). The low noise amplifier may amplify a reception signal with low noise, and the analog-to-digital converter may generate a reception signal by converting the reception signal from an analog signal to digital data.

At this time, the reception signal processing unit 320 may generate a first reception signal using a signal received as the antenna unit operates in an first operation mode.

Additionally, the reception signal processing unit 320 may generate a second reception signal using a signal received as the antenna unit operates in a second operation mode different from the first operation mode.

At this time, the first operation mode may be a MIMO (Multi Input Multi Output) mode, and the second operation mode may be a beam forming mode. At this time, in the above description, the antenna unit first operates in MIMO (Multi Input Multi Output), which is the first operation mode, and then operate in the beam forming mode, which is the second operation mode. However, the embodiment is not limited to this. For example, the antenna unit may first operate in the beam forming mode, which is the second operation mode, and then operate in the MIMO (Multi Input Multi Output) mode, which is the first operation mode.

In addition, the reception signal processing unit 320 may normalize the generated first reception signal and the second reception signal.

For example, a gain of the first reception signal is different from a gain of the second reception signal. For example, a signal level of the first reception signal is different from a signal level of the second reception signal. For example, when the first reception signal is a signal received in MIMO (Multi Input Multi Output) mode and the second reception signal is a signal received in beam forming mode, the signal level of the first reception signal may be significantly greater than the signal level of the second reception signal.

Accordingly, the reception signal processing unit 320 may perform normalization to match the signal level of the first reception signal and the signal level of the second reception signal. For example, the reception signal processing unit 320 may process the signal level of the first reception signal through a first scale factor and process the signal level of the second reception signal through a second scale factor. At this time, the first scale factor may be a value greater than 1, and the second scale factor may be a value less than 1. Accordingly, the reception signal processing unit 320 can scale up the first reception signal according to the first scale factor and scale down the second reception signal according to the second scale factor.

Thereafter, the reception signal processing unit 320 may generate a composite signal by compositing the normalized first reception signal and the second reception signal. For example, the reception signal processing unit 320 may generate the composite signal by compositing the normalized first reception signal and the rectified second reception signal for each element.

At this time, operations related to generation of a first reception signal, generation of a second reception signal, normalization, and generation of a composite signal according to the operation of the reception signal processing unit 320 will be described in more detail below.

Meanwhile, the control unit 330 can drive the sensing device. For example, the control unit 330 can drive the antenna unit of the sensing device. For example, the control unit 330 may perform object sense (detection) using a reception signal obtained through driving the antenna unit.

For example, the control unit 330 may drive the sensing device while the vehicle is driving. For example, the control unit 330 can drive the sensing device while the vehicle is stopped. In addition, the control unit 330 can control the antenna unit to determine whether an object is detected in a region surrounding a current position. To this end, the control unit 330 can process and analyze transmission data and reception signals. For example, the control unit 330 may control the transmission signal processing unit 310 to generate a transmission signal from transmission data. For example, the control unit 330 may control processing of a reception signal of the reception signal processing unit 320. For example, the control unit 330 may synchronize the composite signal delivered from the reception signal processing unit 320 and the transmission signal. For example, the control unit 330 may perform CFAR operation, tracking operation, target selection operation, etc. on the composite signal. For example, the control unit 330 can extract angle information, distance information, and speed information about the object. Preferably, the control unit 330 may obtain object information including the presence or absence of an object, angle information, and distance information of the object from the composite signal in order to provide a rear occupancy alert (ROA: Rear Occupancy Alert) function. Thereafter, the control unit 330 may provide rear occupancy alert (ROA: Rear Occupancy Alert) information using the obtained object information. For example, the control unit 330 may provide rear occupancy alert (ROA) information including the presence or absence of an object, the number of objects, and position information of the object.

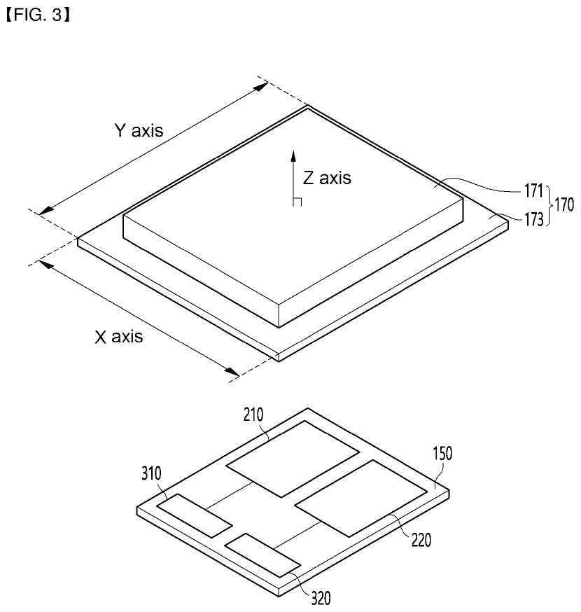

FIG. 3 is a perspective view showing a radome and a second substrate of a vehicle radar device according to an embodiment.

Referring to FIG. 3, the radome 170 may include a cover portion 171 disposed opposite to the second substrate 150 and an edge portion 173 fastened to the case 110. The second substrate 150 may be placed in a space formed by a height difference between the cover portion 171 and the edge portion 173 of the radome 170.

In the radome 170, a direction in which the plurality of antenna arrays are sequentially arranged may be defined as a Y-axis direction, a direction perpendicular to the direction in which the plurality of antenna arrays are sequentially arranged may be defined as a Y-axis direction, and a direction perpendicular to the plurality of antenna arrays may be defined as a Z-axis direction.

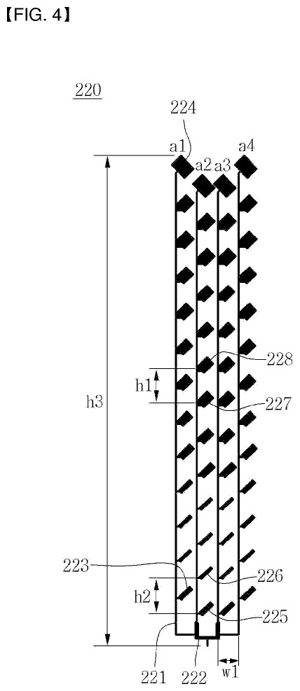

FIG. 4 is a plan view showing a transmitting antenna according to a first embodiment.

Referring to FIG. 3, the first transmitting antenna 220 may include a plurality of arrays as a single channel. In an embodiment, a plurality of arrays may include four arrays and may be, for example, a first array a1, a second array a2, a third array a3 and a fourth array a4.

The first transmitting antenna 220 may include a plurality of feeder lines, a distributing unit, and a plurality of radiators. In the embodiment, the first array a1 may include a feeder line 221, a distributing unit 222, and a plurality of radiators.

The feeder line 221 may be disposed extending from the distributing unit 222 to supply signals to the plurality of radiators. The feeder line 221 is extended in one direction and is arranged in parallel to each other in the other direction. The feeder line 221 is disposed spaced apart from each other at a predetermined distance, and signals may be transmitted from one end to the other end of the feeder line 221.

The distributing unit 222 is disposed between a transmission signal processing unit 310 and the feeder line 221 and may supply signals to the feeder line 221. The distributing unit 222 may distribute signals to the plurality of feeder lines.

The plurality of radiators may radiate signals from the first transmitting antenna 220. The plurality of radiators may form a radiation pattern of the first transmitting antenna 220. The plurality of radiators may be dispersedly disposed on the feeder line 221. The plurality of radiators may be arranged along the feeder line 221. As a result, signals may be supplied from the feeder line 221 to the radiators 220. The plurality of radiators may be made of a conductive material. Here, the plurality of radiators may include at least one of silver (Ag), palladium (Pd), platinum (Pt), copper (Cu), gold (Au), and nickel (Ni).

In an embodiment, a radiator 223 of an array a1 disposed at an edge of a plurality of arrays may be more spaced apart from the distributing unit 222 than a radiator 225 of an array a2 disposed in the middle. That is, in order to adjust the phases of the plurality of arrays to be equal, the radiator 223 of the array a1 disposed at the edge of the plurality of arrays may be disposed more spaced apart from the distributing unit 222 than the radiator 225 of the array a2 disposed in the middle.

In addition, the radiators 223 and 225 closest to the distributing unit 222 of the plurality of arrays may be disposed spaced apart from the feeder line 221. For example, the radiators 223 and 225 may be implemented as a gap coupled patch antenna to reduce an amount of radiation.

A patch of a radiator 224 disposed farthest from the distributing unit 222 of the plurality of arrays may have the largest size among patches of the plurality of radiators to reduce the side lobe of radio waves.

An interval w1 between the third array a3 and the fourth array a4 may be 1.6 mm or more and 1.8 mm or less, preferably 1.8 mm, but is not limited thereto.

In the embodiment, a length h3 of the first array a1 may be 40 mm or more and 42 mm or less, and preferably 41.6 mm, and an interval h2 between a first radiator 225 and a second radiator 226 of the second array a2 may be narrower than an interval h1 between a third radiator 227 and a fourth radiator 228, but is not limited thereto.

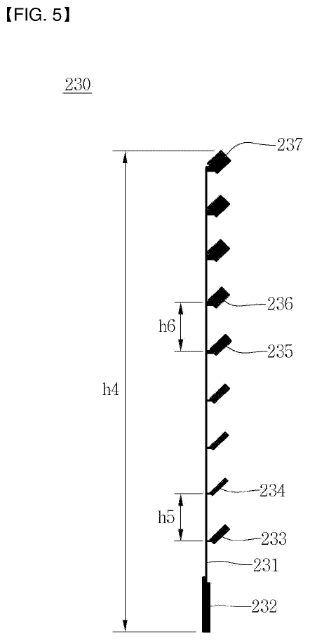

FIG. 5 is a plan view showing a transmitting antenna according to a second embodiment.

Referring to FIG. 5, the second transmitting antenna 230 may include one array as a single channel. The second transmitting antenna 230 may include a feeder line 231, a distributing unit 232, and a plurality of radiators. Descriptions of configurations overlapping with FIG. 4 are omitted.

In an embodiment, a radiator 233 closest to the distributing unit 232 among arrays may be disposed spaced apart from the feeder line 231. For example, the radiator 233 may be implemented as a gap coupled patch antenna to reduce an amount of radiation.

A patch of a radiator 237 disposed farthest from the distributing unit 232 among the arrays may have the largest size among patches of the plurality of radiators to reduce the side lobe of radio waves.

In the embodiment, a length h4 of the array may be 29 mm or more and 31 mm or less, and preferably 29.7 mm, and an interval h5 between a first radiator 233 and a second radiator 234 of the array may be narrower than an interval h6 between a third radiator 235 and a fourth radiator 236, but is not limited thereto.

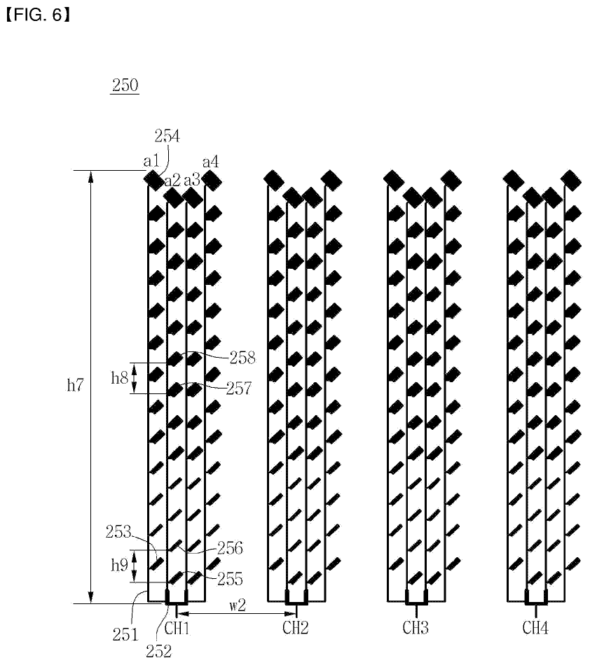

FIG. 6 is a plan view showing a first receiving antenna according to a first embodiment.

Referring to FIG. 6, the first receiving antenna 250 may be comprised of a plurality of channels, and each of the plurality of channels may include a plurality of arrays. In an embodiment, the plurality of channels may include four channels and may include, for example, a first channel (CH1), a second channel (CH2), a third channel (CH3) and a fourth channel (CH4). Each of the plurality of channels may include four arrays and may be, for example, a first array a1, a second array a2, a third array a3 and a fourth array a4.

The first receiving antenna 250 may include a plurality of feeder lines, a distributing unit, and a plurality of radiators. In the embodiment, a first array a1 may include a feeder line 251, a distributing unit 252, and a plurality of radiators. The feeder line 251 may be disposed extending from the distributing unit 252 to supply signals to the plurality of radiators. The feeder line 251 is extended in one direction and is arranged in parallel to each other in the other direction. The feeder line 251 is disposed spaced apart from each other at a predetermined distance, and a signal may be transmitted from one end to the other end of the feeder line 251.

The distributing unit 252 is disposed between the signal processing unit 300 and the feeder line 251 and may supply signals to the feeder line 251. The distributing unit 252 may distribute signals to the plurality of feeder lines. The plurality of radiators may receive signals from the first receiving antenna 250. The plurality of radiators may form a radiation pattern of the first receiving antenna 250. The plurality of radiators may be dispersedly disposed on the feeder line 251. The plurality of radiators may be arranged along the feeder line 251. The plurality of radiators may be made of a conductive material. Here, the plurality of radiators may include at least one of silver (Ag), palladium (Pd), platinum (Pt), copper (Cu), gold (Au), and nickel (Ni).

In an embodiment, a radiator 253 of the array a1 disposed at an edge of the plurality of arrays may be more spaced apart from the distributing unit 252 than a radiator 255 of the array a2 disposed in the middle. That is, in order to adjust the phases of the plurality of arrays to be equal, the radiator 253 of the array a1 disposed at the edge of the plurality of arrays may be disposed more spaced apart from the distributing unit 252 than the radiator 255 of the array a2 disposed in the middle.

In addition, the radiators 253 and 255 closest to the distributing unit 252 of the plurality of arrays may be disposed spaced apart from the feeder line 251. For example, the radiators 253 and 255 may be implemented as a gap coupled patch antenna to reduce an amount of radiation.

A patch of a radiator 254 disposed farthest from the distributing unit 252 of the plurality of arrays may have the largest size among patches of the plurality of radiators to reduce the side lobe of radio waves.

In an embodiment, the first receiving antenna 250 includes four channels, and an interval between the channels may be less than 2λ.

In the embodiment, a length h7 of the first array a1 may be 40 mm or more and 42 mm or less, and preferably 41.6 mm, and an interval h9 between a first radiator 255 and a second radiator 256 of the second array a2 may be narrower than an interval h8 between a third radiator 257 and a fourth radiator 258, but is not limited thereto.

In the embodiment, an interval w2 between the first channel and the second channel may be 7.0 mm or more and 8.0 mm or less, preferably 7.5 mm, but is not limited thereto.

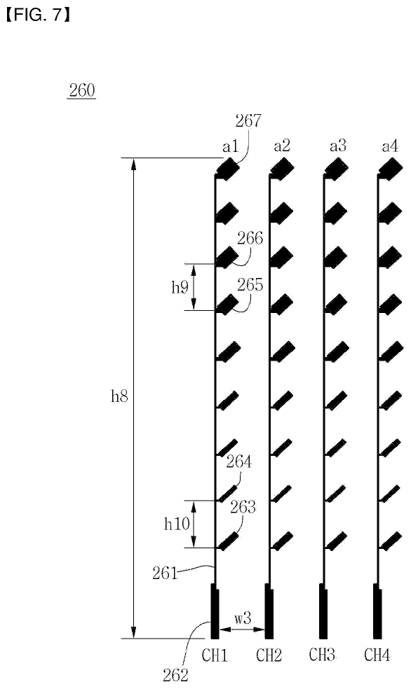

FIG. 7 is a plan view showing a receiving antenna according to a second embodiment.

Referring to FIG. 7, the second receiving antenna 260 may consist of a plurality of channels, and each of the plurality of channels may include one array. In an embodiment, the plurality of channels may include four channels and may include, for example, a first channel (CH1), a second channel (CH2), a third channel (CH3) and a fourth channel (CH4).

The second receiving antenna 260 may include a feeder line 261, a distributing unit 262, and a plurality of radiators. In an embodiment, a radiator 263 closest to the distributing unit 262 of arrays may be disposed spaced apart from the feeder line 261. For example, the radiator 263 may be implemented as a gap coupled patch antenna to reduce an amount of radiation.

A patch of a radiator 267 disposed farthest from the distributing unit 262 of the arrays may have the largest size among patches of the plurality of radiators to reduce the side lobe of radio waves. In an embodiment, the second receiving antenna 260 includes four channels, and an interval between the channels may be less than λ/2. In the embodiment, a length h8 of the array may be 29 mm or more and 31 mm or less, and preferably 29.7 mm, and an interval h10 between a first radiator 263 and a second radiator 264 of the array may be narrower than an interval h9 between a third radiator 265 and a fourth radiator 266, but is not limited thereto.

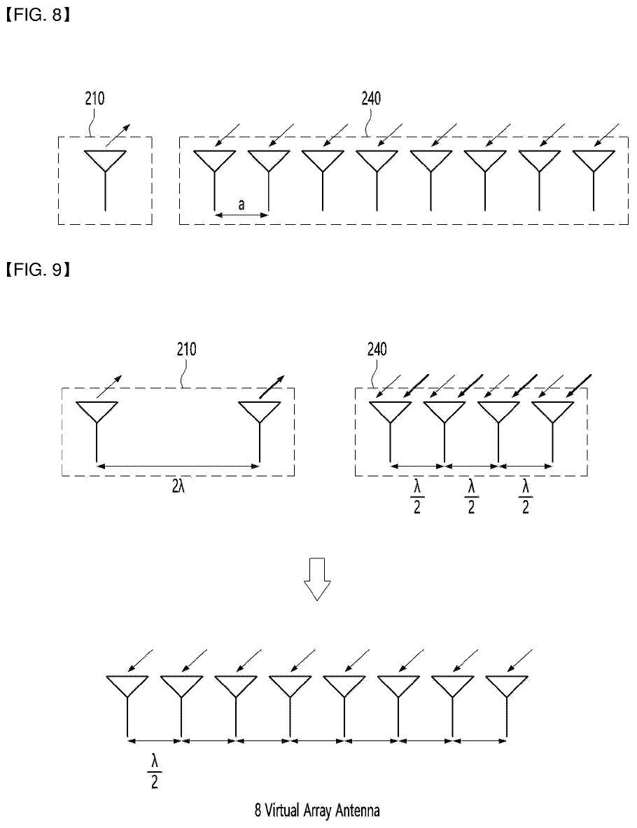

FIGS. 8 to 10 are views for explaining an operation mode of an antenna unit according to an embodiment.

FIG. 8 is a view for explaining a case where the antenna unit operates in a SIMO (Single Input Multi Output) mode, and FIG. 9 is a view for explaining a case where the antenna unit operates in a MIMO (Multi Input Multi Output) mode. FIG. 10 is a view for explaining a case where the antenna unit operates in a beam forming mode.

Referring to FIGS. 8 to 10, antenna operation modes can be broadly divided into three types in frequency modulated continuous wave (FMCW) using multiple array antennas.

The SIMO (Single Input Multi Output) is a method in which one transmission signal is generated from one transmitting antenna, and reception signals corresponding to the transmission signal are respectively received from a plurality of receiving antennas. Here, in the case of the SIMO (Single Input Multi Output) mode, one transmitting antenna and eight receiving antennas are required to obtain eight reception signals.

In addition, And, in the case of MIMO (Multi Input Multi Output) mode, this mode includes a limited number of plural antennas and uses a distance and phase difference between the plurality of antennas to create a plurality of virtual antennas and increases the number of antennas accordingly. This is a mode that can achieve the same performance with a smaller number of antennas than the SIMO (Single Input Multi Output) method. For example, in MIMO (Multi Input Multi Output) mode, two transmitting antennas and four receiving antennas are required to obtain eight reception signals. In the case of the MIMO (Multi Input Multi Output) mode, it has excellent angle resolution because it includes multiple virtual antennas.

Unlike the MIMO (Multi Input Multi Output) mode, the beam forming mode is a method of operating two or more transmitting antennas simultaneously to make the resulting antenna radiation pattern narrower and sharper than the MIMO (Multi Input Multi Output) mode. The beam forming is an antenna technology mainly used in Long Range Radar (LRR), and can obtain a high-gain reception signal using multiple antennas. Based on this, it is possible to detect objects located at a long distance. However, in the case of beam forming mode, there is a problem that the signal-to-noise ratio decreases as noise increases along with the object detection signal.

Meanwhile, in order to provide a rear occupancy alert (ROA: Rear Occupancy Alert) function within a vehicle, in the comparative example, the antenna was operated in MIMO (Multi Input Multi Output) mode, and object detection was performed using the resulting reception signal.

At this time, the signal received in the MIMO (Multi Input Multi Output) mode has high angle resolution, but has a problem of low signal strength due to low gain.

Accordingly, if a small-sized object (for example, an infant) exists in the rear seat of a vehicle, there is a problem in which the small-sized object is not detected due to the low gain. At this time, the reception signal obtained through MIMO (Multi Input Multi Output) may be scaled up by a certain scale factor and object detection may be performed using the scaled up signal. However, in this case, the noise signal is also scaled up, resulting in a decrease in sensing accuracy.

In addition, if the rear occupancy alert function is provided using a reception signal received through the beam forming mode, sensing of small-sized moving objects is possible due to high gain, but the intensity of the noise signal is also increased accordingly. Accordingly, there is a false alarm problem in which an alarm is generated by recognizing a noise signal as a moving object. Furthermore, if the rear occupancy alert function is provided using the reception signal received through the beam forming mode, there is a problem that the signal of a large moving object appears spread out due to low angle resolution. Accordingly, there is a problem of not detecting an exact location of a moving object.

Accordingly, in the embodiment, it is possible to detect all moving objects regardless of size, improve signal to noise ratio (SNR), and accurately detect the location of the detected moving object.

For this purpose, the embodiment generates a composite signal by compositing a first reception signal obtained in the MIMO (Multi Input Multi Output) mode and a second reception signal obtained in the beam forming mode, and performs an object detection operation using the generated composite signal.

To this end, the control unit 330 can start the operation of the sensing device according to a driving state of a vehicle equipped with the sensing device. As an example, the sensing device of the embodiment can be used to provide a rear occupancy alert (ROA: Rear Occupancy Alert) function. In addition, if the sensing device is used to provide a rear occupancy alert (ROA: Rear Occupancy Alert) function, the control unit 330 can start the operation of the sensing device when the vehicle stops driving and the engine is turned off. For example, the control unit 330 may detect the presence of a rear seat passenger after the vehicle's engine is turned off and provide a notification function accordingly. However, the embodiment is not limited to this. For example, the control unit 330 can cause the sensing device to operate even while the vehicle is driving, according to the functions provided by the sensing device.

Hereinafter, the operation of sensing an object by a sensing device according to an embodiment will be described in more detail.

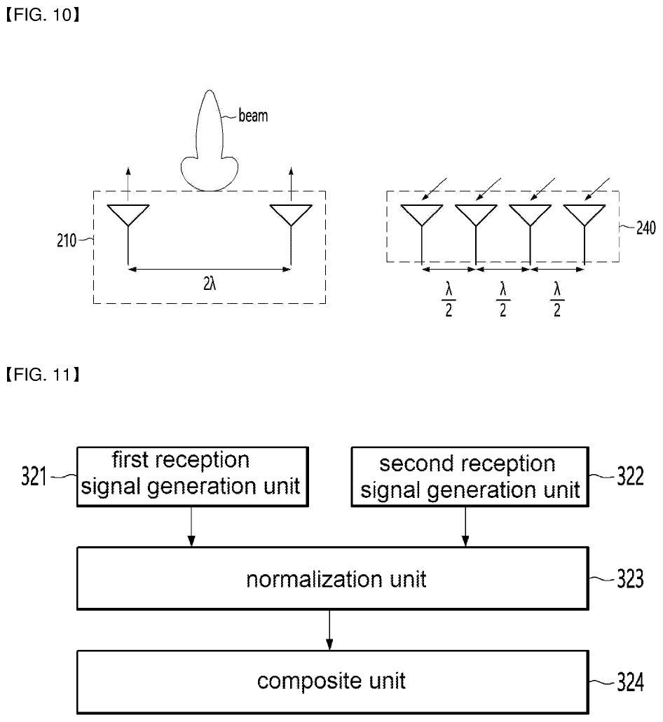

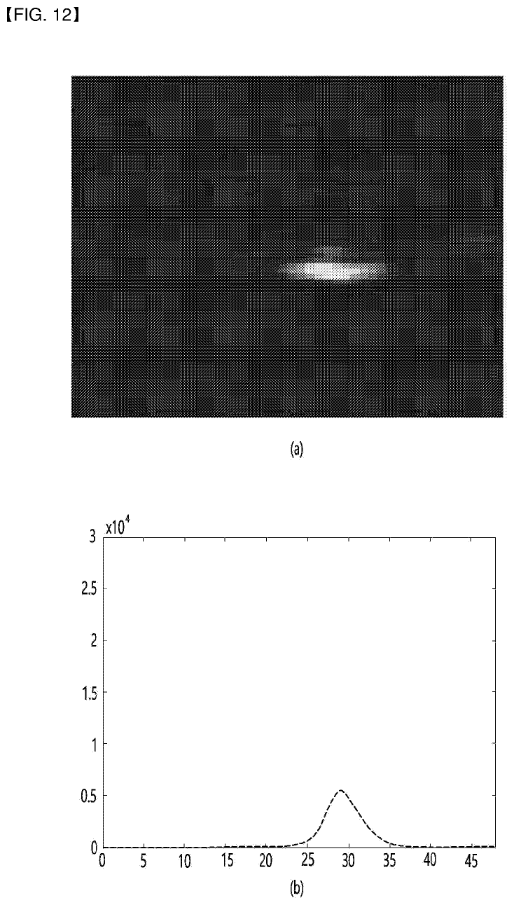

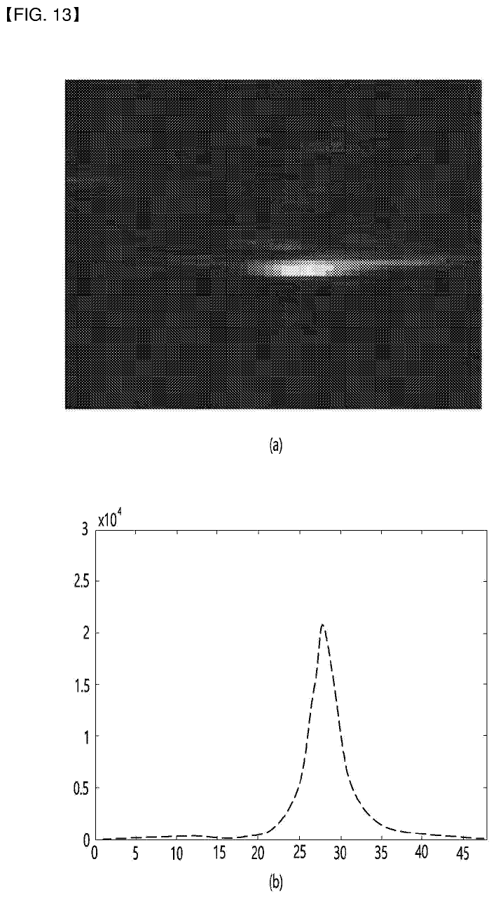

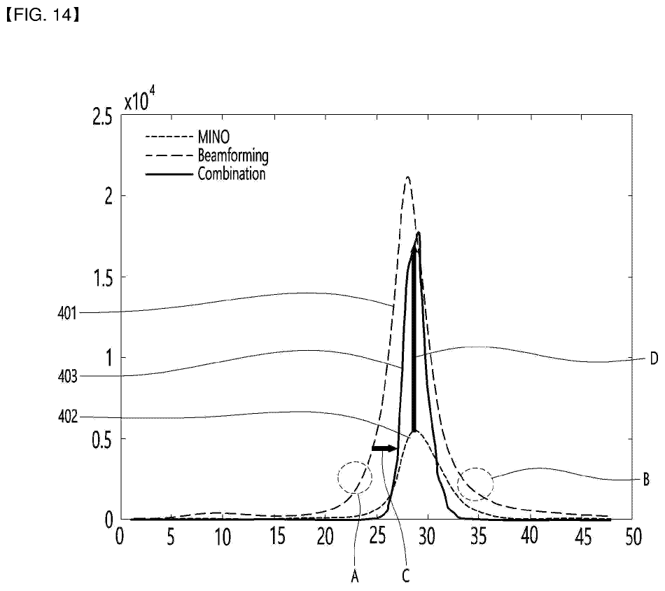

FIG. 11 is a block diagram showing a detailed configuration of a reception signal processing unit according to an embodiment, FIG. 12 is a view showing a first reception signal according to an embodiment, FIG. 13 is a view showing a second reception signal according to an embodiment, and FIG. 14 is a view showing a composite signal according to an embodiment.

Hereinafter, the operation of the sensing device will be described in detail with reference to FIGS. 11 to 14.

The control unit 330 controls the operations of the transmitting antenna unit 210 and the receiving antenna unit 240 when a condition for starting the operation of the sensing device is detected.

For example, when an operation start condition is detected, the control unit 330 causes the transmitting antenna unit 210 to operate in the first operation mode. At this time, the first operation mode may be a MIMO (Multi Input Multi Output) mode, or alternatively, the first operation mode may be a beam forming mode.

The receiving antenna unit 240 may receive a signal according to a first transmission signal transmitted from the transmitting antenna unit 210 as the transmitting antenna unit 210 operates in the first operation mode.

At this time, when a signal for the first operation mode is received from the receiving antenna unit 240, the reception signal processing unit 320 may generate a first reception signal corresponding thereto.

In addition, the control unit 330 may control the transmitting antenna unit 210 to operate in the second operation mode when the reception signal processing unit 320 completes generation of the first reception signal. For example, the second operation mode may be a beam forming mode, or alternatively, the second operation mode may be a MIMO (Multi Input Multi Output) mode.

In addition, the receiving antenna unit 240 may receive a signal according to the second transmission signal transmitted from the transmitting antenna unit 210 as the transmitting antenna unit 210 operates in the second operation mode.

At this time, when a signal for the second operation mode is received from the receiving antenna unit 240, the reception signal processing unit 320 may generate a second reception signal corresponding thereto.

For this purpose, the reception signal processing unit 320 includes a reception signal generation unit. For example, the reception signal processing unit 320 can include a first reception signal generation unit 321 that generates a first reception signal using a signal received from the receiving antenna unit 240 in the first operation mode. In addition, the reception signal processing unit 320 can include a second reception signal generation unit 322 that generates a second reception signal using the signal received from the receiving antenna unit 240 in the second operation mode. Meanwhile, the first reception signal generation unit 321 and the second reception signal generation unit 322 are separated to distinguish the generated signals, and it may be possible to generate the first reception signal and the second reception signal according to each mode in one reception signal generation unit.

The first reception signal generation unit 321 and the second reception signal generation unit 322 can perform range fast Fourier transform and Doppler FFT processing, and can generate a heat map according to the above processing to generate a first reception signal and a second reception signal, respectively.

FIG. 12(a) shows a heat map generated in the first operation mode, and FIG. 12(b) shows the first reception signal generated in the first operation mode. In (b) of FIG. 12, a x-axis may mean an angle (e.g., a position of an object), and a y-axis may mean a gain (e.g., signal strength level).

FIG. 13(a) shows a heat map generated in the second operation mode, and FIG. 13(b) shows the second reception signal generated in second first operation mode. In (b) of FIG. 13, a x-axis may mean an angle (e.g., a position of an object), and a y-axis may mean a gain (e.g., signal strength level).

In conclusion, the first reception signal generation unit 321 receives frames received in a first operation mode. In addition, the first reception signal generation unit 321 can generate the first reception signal for the first operation mode through FFT conversion and heat map generation.

In addition, the second reception signal generation unit 322 receives frames received in a second operation mode. In addition, the second reception signal generation unit 322 can generate the second reception signal for the second operation mode through FFT conversion and heat map generation.

Thereafter, the reception signal processing unit 320 may generate a composite signal that composites the first reception signal and the second reception signal generated by the reception signal generation unit.

At this time, the first reception signal is a signal obtained in MIMO (Multi Input Multi Output) mode, and the second reception signal is a signal obtained in beam forming mode. Accordingly, a level of the first reception signal may be different from a level of the second reception signal. For example, a signal level of the second reception signal is greater than a signal level of the first reception signal due to the high gain characteristic of the beam forming mode.

Accordingly, the reception signal processing unit 320 may include a normalization unit 323 that normalizes the first reception signal and the second reception signal generated by the first reception signal generation unit 321 and the second reception signal generation unit 322.

That is, the first reception signal and the second reception signal (e.g., the first heat map and the second heat map) are obtained from the first reception signal generation unit 321 and the second reception signal generation unit 322, and the normalization unit 323 may perform normalization by scaling the levels of the first reception signal and the second reception signal to values of 0 to 1.

For example, the normalization unit 323 may determine a first scale factor for the first reception signal for the normalization. Additionally, the normalization unit 323 may determine a second scale factor for the second reception signal for the normalization.

Additionally, the normalization unit 323 may scale the first reception signal based on the first scale factor and scale the second reception signal based on the second scale factor.

For example, the normalization unit 323 may determine a reference value for determining the first scale factor and the second scale factor. The reference value may be set based on a first peak value of the first reception signal and a second peak value of the second reception signal. For example, the reference value may be set to an intermediate value between the first peak value and the second peak value. As another example, the reference value may be set to the second peak value. Hereinafter, a case where the reference value is set to an intermediate value between the first peak value and the second peak value will be described.

Referring to (b) of FIG. 12, the first peak value in the first reception signal is approximately 0.5(*10⁴).

Additionally, referring to (b) of FIG. 13, the second peak value in the second reception signal is approximately 2(*10⁴).

Accordingly, the normalization unit 323 may set the reference value to 1.25(*10⁴) for the normalization process. However, the embodiment is not limited to this, and the reference value may be set to any one of the values between 0.5(*10⁴) and 2(*10⁴).

The normalization unit 323 may determine a first scale factor according to a difference between the first peak value and the reference value based on the reference value. At this time, the first peak value is smaller than the reference value, and accordingly, the first scale factor may have a value greater than 1. And, the normalization unit 323 may scale up the first reception signal based on the determined first scale factor.

Additionally, the normalization unit 323 may determine a second scale factor according to a difference between the second peak value and the reference value based on the reference value. At this time, the second peak value may not be greater than the second reference value. Accordingly, the second scale factor may have a value that exceeds 0 and is 1 or less. Additionally, the normalization unit 323 may scale down the second reception signal based on the determined second scale factor.

Since the level of the first reception signal and the level of the second reception signal are different from each other, the normalization unit 323 can scale up the first reception signal and/or scale down the second reception signal to match the level of the first reception signal and the level of the second reception signal.

The reception signal processing unit 320 may generate a composite signal obtained by compositing the first reception signal and the second reception signal normalized through the normalization unit 323. To this end, the reception signal processing unit 320 may include a composite unit 324 that receives and composites the normalized first and second reception signals through the normalization unit 323.

The composite unit 324 may generate a composite signal through a multiplication operation between each element of the normalized first reception signal and the second reception signal.

For example, each of the above elements may mean an angle corresponding to the x-axis in the first reception signal and the second reception signal. And, the multiplication operation may mean multiplying gain values for a same angle in the first reception signal and the second reception signal. At this time, the composite unit 324 may generate the composite signal through an operation other than the multiplication operation (for example, an addition operation). However, in the embodiment, the composite signal is generated through a multiplication operation so that the signal level of the object detection signal can be further increased while the signal level of the noise signal can be further reduced.

Generation of the composite signal may proceed as follows.

The x-axis of the composite signal may have values from level 0 to level 50, as in the first reception signal and the second reception signal. And, the x-axis may mean an angle. For example, the x-axis may refer to a position of an object. For example, if the detection range of the sensing device in the embodiment is 180 degrees, level 1 of the x-axis in FIG. 14 may actually mean ‘3.6 degrees’. For example, in this case, level 30 of the x-axis may mean 108 degrees.

As shown in FIG. 14, the first reception signal 401 has a high signal level (e.g., gain value), but has low angle resolution. Accordingly, even if the object is substantially located between 25 and 32 based on the x-axis value, the object may have the same characteristics as if it were located between 20 and 40.

In addition, the second reception signal 402 has high angle resolution, but has a low signal level, so even if an actual object is detected, the level of the corresponding object detection signal is low.

Accordingly, in the embodiment, a composite signal 403 is generated by compositing the first reception signal 401 and the second reception signal 402 using the composite unit 324. The composite signal 403 can be generated by multiplying the levels between each element of the normalized first reception signal 401 and the normalized second reception signal 402.

For example, if the level of the first reception signal 401 is ‘2’ at ‘20’ on the x-axis and the level of the second reception signal 402 is ‘0’ at ‘20’ on the x-axis, the signal level of the composite signal 403 becomes 0 at ‘20’ on the x-axis. For example, if the level of the first reception signal 401 is ‘2’ at ‘25’ on the x-axis and the level of the second reception signal 402 is ‘1.5’ at ‘25’ on the x-axis, the signal level of the composite signal 403 becomes ‘3’ at axis ‘25’.

In addition, the embodiment generates a composite signal 403 through the above multiplication operation, and thus the level of the actual object detection signal can be improved while reducing the signal level of noise.

At this time, cases in the multiplication operation for generating the composite signal 403 can be divided as follows.

### (1) First Case: Multiplication Calculate of a Noise Portion of the First Reception Signal and a Noise Portion of the Second Reception Signal

As described above, a noise portion may exist in the first reception signal, and a noise portion may also exist in the second reception signal. At this time, if the multiplication calculate of the noise portion of the first reception signal and the noise portion of the second reception signal is performed (if the noise signal levels are multiplied), the corresponding resulting value becomes lower, and thus the signal-to-noise ratio can be improved.

### (2) Second Case: Multiplication Calculation of the Noise Portion of the First Reception Signal and the Object Detection Signal Portion of the Second Reception Signal

At this time, there is a difference in angle resolution between the first operation mode and the second operation mode. As a result, there may be a portion that is recognized as noise in the first reception signal but is recognized as an object detection signal in the second reception signal. In addition, when the multiplication operation of this portion is performed, it is processed as noise, and the angle resolution, which is a disadvantage in the second operation mode, can be improved.

### (3) Third Case: Multiplication Operation of the Object Detection Signal Portion of the First Reception Signal and the Object Detection Signal Portion of the Second Reception Signal

As described above, when the level of the object detection signal portion of the first reception signal and the object detection signal portion of the second reception signal are multiplied, the low signal value due to low gain, which is a disadvantage of the object detection signal portion of the first reception signal, can be improved to a high signal value.

In conclusion, in the embodiment, when a composite signal is generated by multiplying the normalized first reception signal and the second reception signal as described above, the signal level in the noise portion becomes lower, thereby improving the signal-to-noise ratio. In addition, the signal level in the portion where both noise and object detection signals exist in the first reception signal and the second reception signal is reduced to a low value through a multiplication operation, as a result, the corresponding part can be processed as noise to improve angular resolution. And, the signal level in the portion where the object detection signal exists in both the first reception signal and the second reception signal is further increased through the multiplication operation, as a result, even small-sized objects have a detectable gain value. Accordingly, in the embodiment, detection accuracy can be improved.

For example, the first reception signal 401 includes first portions A and B corresponding to noise. At this time, the signal level of the second reception signal 402 corresponding to the first portions A and B has a value of substantially 0. Accordingly, the noise included in the first reception signal 401 may be removed in the composite signal 403 of the embodiment.

Additionally, the composite signal 403 of the embodiment can improve the angle resolution of the composite unit 324 as the signal level is lowered (C) in the portion corresponding to the second case.

Furthermore, the composite signal 403 of the embodiment can increase object detection accuracy as the signal level becomes higher (D) in the portion corresponding to the third case.

Hereinafter, a method of operating a sensing device according to an embodiment will be described.

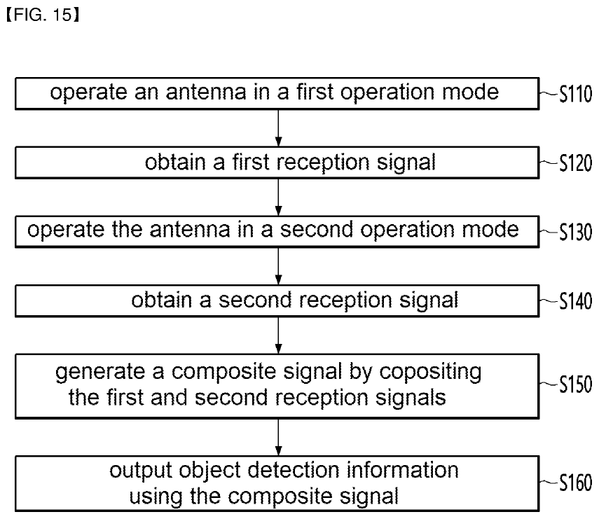

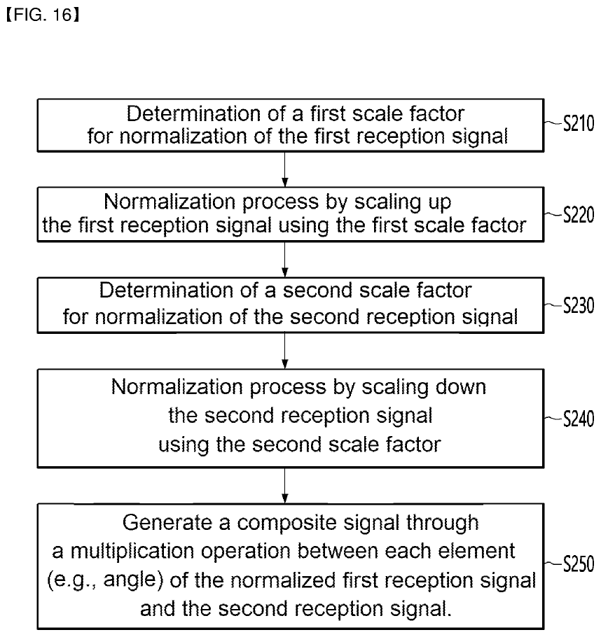

FIG. 15 is a flowchart for explaining a method for operating a sensing device according to an operation sequence according to an embodiment, and FIG. 16 is a flowchart showing a detailed operation of a process of generating a composite signal of FIG. 15.

Referring to FIG. 15, the control unit 330 in the embodiment operates the transmitting antenna unit 210 in the first operation mode (S110).

For example, the control unit 330 causes the plurality of transmitting antennas constituting the transmitting antenna unit 210 to each transmit a transmission signal at a certain time. For example, when the transmitting antenna unit 210 includes a first transmitting antenna and a second transmitting antenna, the first control unit is configured to transmit a first transmission signal through the first transmitting antenna at a first time and transmit a second transmission signal through the second transmitting antenna at a second time after the first time. For example, the control unit 330 causes the transmitting antenna unit 210 to operate in MIMO (Multi Input Multi Output) corresponding to the first operation mode.

Thereafter, the control unit 330 ensures that the signal for the transmitted signal is received through the receiving antenna unit 120 (S120). In addition, the control unit 330 ensures that a first reception signal for the received signal is obtained through the reception signal processing unit 320.

Thereafter, the control unit 330 operates the transmitting antenna unit 210 in the second operation mode (S120).

For example, the control unit 330 causes a plurality of transmitting antennas constituting the transmitting antenna unit 210 to simultaneously transmit a transmission signal. For example, the transmitting antenna unit 210 may include a first transmitting antenna and a second transmitting antenna. Also, the first transmitting antenna and the second transmitting antenna can each operate at the same time to transmit one transmission signal. For example, the control unit 330 causes the transmitting antenna unit 210 to operate in a beam forming mode corresponding to the second operation mode.

Thereafter, the control unit 330 ensures that a signal for the transmitted signal is received through the receiving antenna unit 120 (S140). Thereafter, the control unit 330 causes a second reception signal for the received signal to be obtained through the reception signal processing unit 320.

Thereafter, the reception signal processing unit 320 generates a composite signal by compositing the obtained first reception signal and the second reception signal (S150).

Thereafter, the control unit 330 may receive the composite signal generated through the reception signal processing unit 320 and obtain object information using the received composite signal (S160). Thereafter, the control unit 330 may provide rear occupancy alert (ROA: Rear Occupancy Alert) information using object information obtained using the composite signal. For example, the control unit 330 may provide information such as whether an object exists in a rear seat of the vehicle, and if an object exists in the rear seat, the number of objects and the location of the object.

Meanwhile, referring to FIG. 16, the reception signal generation unit of the reception signal processing unit 320 may generate a first reception signal and a second reception signal using the signal received through the receiving antenna unit in each mode. For example, the first reception signal generation unit 321 may generate a first reception signal using a signal received through the receiving antenna unit in the first operation mode. For example, the second reception signal generation unit 322 may generate a second reception signal using a signal received through the receiving antenna unit in the second operation mode.

Thereafter, the normalization unit 323 of the reception signal processing unit 320 may perform normalization to match the levels of the first reception signal and the second reception signal by using the first peak value of the received first reception signal and the second peak value of the second reception signal.

To this end, the normalization unit 323 may determine the first scale factor of the first reception signal for normalization (S210).

At this time, the first scale factor may have a value greater than 1. Accordingly, the normalization unit 323 in the embodiment may scale up the first reception signal based on the first scale factor (S220).

Additionally, the normalization unit 323 may determine a second scale factor of the second reception signal for normalization (S230).

At this time, the second scale factor may have a value less than 1. Accordingly, the normalization unit 323 in the embodiment may scale down the second reception signal based on the second scale factor (S240).

Thereafter, the composite unit 324 may generate a composite signal through a multiplication operation between each element of the normalized first reception signal and the second reception signal (S250).

Features, structures, effects, etc. described in the above embodiments are included in at least one embodiment, and it is not necessarily limited to only one embodiment. Furthermore, features, structures, effects, etc. illustrated in each embodiment can be combined or modified for other embodiments by those of ordinary skill in the art to which the embodiments belong. Accordingly, the contents related to such combinations and variations should be interpreted as being included in the scope of the embodiments.

In the above, the embodiment has been mainly described, but this is only an example and does not limit the embodiment, and those of ordinary skill in the art to which the embodiment pertains will appreciate that various modifications and applications not illustrated above are possible without departing from the essential characteristics of the present embodiment. For example, each component specifically shown in the embodiment can be implemented by modification. And the differences related to these modifications and applications should be interpreted as being included in the scope of the embodiments set forth in the appended claims.

1. A method of operating a sensing device comprising:
driving an antenna unit in a first operation mode;
obtaining a first reception signal in the first operation mode;
driving the antenna unit in a second operation mode different from the first operation mode;
obtaining a second reception signal in the second operation mode;
obtaining a composite signal by compositing the first reception signal and the second reception signal; and
obtaining object detection information by using the obtained composite signal.

2. The method of claim 1, wherein the first operation mode is MIMO (Multi Input Multi Output) mode, and
wherein the second operation mode is beam forming mode.

3. The method of claim 1, wherein the first reception signal includes a first heat map, and
wherein the second reception signal includes a second heat map.

4. The method of claim 1, wherein the antenna unit includes a plurality of transmitting antennas, and
wherein the driving the antenna unit in the first operation mode includes allowing transmission signals to be transmitted from each of the plurality of transmitting antennas at a certain time interval, and
wherein the driving the antenna unit in the second operation mode includes simultaneously operating the plurality of transmitting antennas to transmit one transmission signal.

5. The method of claim 1, wherein the obtaining of the composite signal includes normalizing the first reception signal and the second reception signal.

6. The method of claim 5, wherein the normalizing of the first reception signal and the second reception signal includes:
determining a first scale factor for scaling the first reception signal;
determining a second scale factor for scaling the second reception signal;
scaling the first reception signal based on the first scale factor; and
scaling the second reception signal based on the second scale factor.

7. The method of claim 6, wherein the first scale factor is greater than 1 and the second scale factor is less than 1,
wherein the scaling the first reception signal includes scaling up the first reception signal based on the determined first scale factor,
wherein the scaling the second reception signal includes scaling down the second reception signal based on the determined second scale factor.

8. The method of claim 1, wherein the obtaining the composite signal includes obtaining the composite signal by multiplying the first reception signal and the second reception signal.

9. The method of claim 1, wherein the obtaining the object detection information includes obtaining information including presence or absence of the object, a number of objects, and a position of the object.

10. A sensing device comprising:
a transmitting antenna unit including a plurality of transmitting antennas;
a receiving antenna unit including a plurality of receiving antennas;
a reception signal processing unit configured to process signals received through the receiving antenna unit; and
a control unit configured to detect an object using a signal processed through the reception signal processing unit,
wherein the control unit is configured to:
control the transmitting antenna unit and the receiving antenna unit to operate in a first operation mode,
control the first reception signal to be generated through the reception signal processing unit in the first operation mode,
control the transmitting antenna unit and the receiving antenna unit to operate in a second operation mode different from the first operation mode,
control a second reception signal to be generated through the reception signal processing unit in the second operation mode,
control a composite signal to be generated by combining the first reception signal and the second reception signal through the signal processing unit, and
detect the object using the generated composite signal.

11. The sensing device of claim 10, wherein the first operation mode is MIMO (Multi Input Multi Output) mode, the second operation mode is beam forming mode.

12. The sensing device of claim 11, wherein the control unit is configured to:
allow transmission signals to be transmitted from each of the plurality of transmitting antennas at a certain time interval, and
allow simultaneously operate the plurality of transmitting antennas to transmit one transmission signal.

13. The sensing device of claim 11, wherein the reception signal processing unit includes:
a first reception signal generation unit configured to generate the first reception signal, and
a second reception signal generation unit configured to generate the second reception signal, and
a normalization unit configured to normalize the generated first and second reception signals.

14. The sensing device of claim 13, wherein the normalization unit is configured to:
determine a first scale factor for the first reception signal and a second scale factor for the second reception signal, and
scale and normalize the first and second reception signals based on the determined first scale factor and second scale factor.

15. The sensing device of claim 14, wherein the first scale factor is greater than 1, and the second scale factor is less than 1, and
wherein the normalization unit is configured to increase the level of the first reception signal based on the first scale factor and to decrease the level of the second reception signal based on the second scale factor.

16. The sensing device of claim 13, wherein the reception signal processing unit includes a composite unit configured to generate the composite signal by compositing the first reception signal and the second reception signal normalized through the normalization unit.

17. The sensing device of claim 16, wherein the control unit is configured to detect a presence or absence of an object, a number of objects, and a position of the object using the composite signal generated through the composite unit.

18. A vehicle sensing system comprising:
a sensing device disposed inside the vehicle; and
a notification unit configured to provide notification information corresponding to an object present in a rear seat of the vehicle based on information obtained using the sensing device,
wherein the notification information includes a presence or absence of an object, a number of objects, and a position of the object,
wherein the sensing device comprises:
a transmitting antenna unit including a plurality of transmitting antennas;
a receiving antenna unit including a plurality of receiving antennas;
a reception signal processing unit configured to process signals received through the receiving antenna unit; and
a control unit configured to detect an object using a signal processed through the reception signal processing unit,
wherein the control unit is configured to:
control the transmitting antenna unit and the receiving antenna unit to operate in a first operation mode,
control the first reception signal to be generated through the reception signal processing unit in the first operation mode,
control the transmitting antenna unit and the receiving antenna unit to operate in a second operation mode different from the first operation mode,
control a second reception signal to be generated through the reception signal processing unit in the second operation mode,
control a composite signal to be generated by combining the first reception signal and the second reception signal through the signal processing unit, and
detect the object using the generated composite signal.

19. The vehicle sensing system of claim 18, wherein the first operation mode is MIMO (Multi Input Multi Output) mode, the second operation mode is beam forming mode,
wherein the control unit is configured to:
allow transmission signals to be transmitted from each of the plurality of transmitting antennas at a certain time interval, and
allow simultaneously operate the plurality of transmitting antennas to transmit one transmission signal.

20. The vehicle sensing system of claim 19, wherein the reception signal processing unit includes:
a first reception signal generation unit configured to generate the first reception signal, and
a second reception signal generation unit configured to generate the second reception signal, and
a normalization unit configured to normalize the generated first and second reception signals,
wherein the normalization unit is configured to:
determine a first scale factor for the first reception signal and a second scale factor for the second reception signal, and
scale and normalize the first and second reception signals based on the determined first scale factor and second scale factor.
